(19) United States
(12) Patent Application Publication
(10) Pub. No.: US 2005/0170725 A1
(43) Pub. Date: Aug. 4, 2005

(54) Wildfire protection

(76) Inventor: R. Peter Kimener, Loveland, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/030,578

(22) Filed: Jan. 6, 2005

Related U.S. Application Data
(60) Provisional application No. 60/534,564, filed on Jan. 6, 2004.

(51) Int. Cl. B32B 5/02; B32B 27/04; B32B 5/26; B27N 9/00

(52) U.S. Cl. 442/239; 428/920; 428/921; 442/131; 442/381; 442/268; 442/389; 442/376; 442/228

(57) ABSTRACT

A method of protecting an asset from destruction resulting from exposure to at least one of fire and thermal energy comprising: (a) identifying a pending threat capable of at least substantially destroying an asset by exposure to at least one of fire and thermal energy; (b) deploying a barrier, that includes a fire resistant layer and a thermal energy reflective layer, to separate the asset from the pending threat; and (c) securing the barrier to at least one of the ground, the asset itself, and a support structure; (d) wherein the act of securing the barrier is operative to retain at least one of the fire resistant layer and the thermal energy shield layer between the asset and the pending threat.

### CROSS REFERENCE TO RELATED APPLICATIONS

This application claims the benefit of U.S. Provisional Patent Application Ser. No. 60/534,564, filed Jan. 6, 2004, and entitled “WILDFIRE PROTECTION,” the disclosure of which is incorporated herein by reference.

### BACKGROUND

1. Field of the Invention

The present invention is directed to fire and thermal energy protection for structures, vehicles, trailers, boats, and other assets, that are or may become exposed to a fire or a high temperature thermal energy source. More specifically, the present invention is directed to a fire and thermal energy protective barrier that may be selectively deployed in proximity to an asset to inhibit degradation and/or destruction that might would otherwise result from unprotected exposure to a fire or a high temperature thermal energy source.

2. Background of the Invention

Each year hundreds of acres of land and the contents thereof are consumed by wildfires. A property owner generally has some assets that are mobile, such as a car, truck, or utility trailer, while other assets such as residential housing and associated barns or other buildings may be immovable. Thus, residents of acreage susceptible to wildfires and other heat related hazards have relied on water hoses coupled to a water supply and/or other chemical or liquid treatments to ward off fires approaching fixed and mobile assets. Fixed assets, generally including buildings and residential housing, are sometimes engulfed and incinerated when water and/or chemicals applied thereto are inoperative in sufficiently retarding the thermal energy given off by oncoming fires. This is particularly the case where water shortages do not readily permit residential housing owners to retard the oncoming fires or the owners are forced to evacuate from the residence in light of the veracity of the oncoming fires. Likewise, fast moving wildfires may not make it possible to adequately move each and every one of the mobile assets that may be located within a storage building or otherwise on a property in the path of a wildfire. In sum, protecting fixed structures has been a problem for mankind throughout his habitation of earth.

Therefore, there is a need for a method and associated apparatus to protect assets against degradation and/or destruction from exposure to fire and high temperature thermal energy sources.

### SUMMARY OF THE INVENTION

The present invention is directed to fire and thermal energy protection for structures, vehicles, trailers, boats, and other assets, that are or may become exposed to a fire or a high temperature thermal energy source. More specifically, the present invention is directed to a protective barrier that may be selectively deployed in proximity to an asset to inhibit degradation and/or destruction that might would otherwise result from unprotected exposure to a fire or a high temperature thermal energy source.

The present invention includes an exemplary protective blanket that shields underlying assets from fire and high temperature thermal energy sources. The blanket may be comprised of a fire resistant layer and a thermal energy resistant/reflective layer, with each layer including one or more properties of protection. The blanket is deployed over or around the asset and secured to the ground or a support structure associated with the asset to retain the relative position of the blanket between the asset and the fire or the high temperature thermal energy source. Numerous methods are available for securing the blanket between the asset and the fire or the high temperature thermal energy source, several of which are discussed in greater detail below. A further exemplary blanket may be configured to mate with the exterior dimensions of the asset or be comprised of reconfigurable segments that are match respective exterior dimensions of the asset.

Optionally, the blanket may be mounted to the asset and be deployed automatically to protect the asset. An exemplary embodiment in accordance with the present invention includes having a protective blanket mounted on the roof or top of the structure within an enclosure adapted to open automatically subsequent to detection of a pending threat to the asset.

Further exemplary embodiments include a protective blanket mounted to a portable asset that is adapted to be deployed automatically to protect the asset subsequent to identifying a potential threat. Further exemplary embodiments may be manually deployed subsequent to identification of a potential threat, where the blanket is housed within its own enclosure mounted to the portable asset.

The exemplary protective blankets of the present invention may also include passages therethrough for selective egress of humans between the asset and the environment surrounding the blanket.

The exemplary protective blankets of the present invention are adapted to be deployed and mounted to the ground or other support structure to maintain the relative position of the blanket with respect to the asset. An exemplary mounting technique includes utilization of integrated fire and heat resistant fasteners or cables to mount the blanket to secure anchors mounted within the ground.

It is a first aspect of the present invention to provide a method of protecting an asset from destruction resulting from exposure to at least one of fire and thermal energy comprising: (a) identifying a pending threat capable of at least substantially destroying an asset by exposure to at least one of fire and thermal energy; (b) deploying a barrier, that includes a fire resistant layer and a thermal energy reflective layer, to separate the asset from the pending threat; and (c) securing the barrier to at least one of the ground, the asset itself, and a support structure, where the act of securing the barrier is operative to retain at least one of the fire resistant layer and the thermal energy shield layer between the asset and the pending threat.

In a more detailed embodiment of the first aspect, the barrier is a blanket. In yet another more detailed embodiment, the barrier is secured to the ground and securing the barrier to the ground includes coupling the barrier to anchors secured in the ground. In a further detailed embodiment, the method further comprises mounting an enclosure to the asset, where the enclosure is adapted to house at least a portion of the barrier prior to deployment of the barrier. In still a further detailed embodiment, the method further comprises mounting an enclosure in close proximity to the asset, where the enclosure is adapted to house at least a portion of the barrier prior to deployment of the barrier. In a more detailed embodiment, the asset includes at least one of a residential structure, a commercial structure, an industrial structure, and an institutional structure.

In yet another more detailed embodiment of the first aspect, the asset includes a residential structure, and the method further includes the act of mounting an enclosure, housing at least a portion of the barrier therein, to at least one of a roof, a wall, and a framing structure associated with the residential structure to facilitate rapid deployment of the barrier subsequent to identification of the pending threat. In still another more detailed embodiment, the fire resistant layer includes at least one of a nonconductive carbonized acrylic fiber layer and a fiberglass layer, and the thermal energy reflective layer includes an aluminum containing coating.

It is a second aspect of the present invention to provide a protective apparatus for use in isolating protectable assets from substantial destruction resulting from at least one of fire and thermal energy, the protective barrier comprising: (a) a protective barrier blanket that includes a fire resistant layer operatively coupled to a thermal energy shield layer, the fire resistant layer adapted to at least partially interpose the thermal energy shield layer and a protectable asset, wherein at least one of the fire resistant layer and the thermal energy shield layer is at least partially operative to reduce exposure of the protectable asset from a pending threat of at least one of fire and thermal energy; and (b) fasteners operatively coupled to at least one of the fire resistant layer and the thermal energy shield layer, the fasteners adapted to retain in relative position at least one of the fire resistant layer and the thermal energy shield layer between the protectable asset and the pending threat.

In a more detailed embodiment of the second aspect, the protective apparatus further comprises an enclosure for housing at least a portion of the protective barrier blanket. In yet another more detailed embodiment, the enclosure is at least one of permanently mounted and temporarily mounted to the protectable asset. In a further detailed embodiment, the enclosure is at least one of permanently mounted and temporarily mounted in proximity to the protectable asset. In still a further detailed embodiment, the enclosure automatically opens to provide access to the protective barrier blanket in response to detection of the pending threat. In a more detailed embodiment, In a more detailed embodiment, the fasteners include anchors mounted to a permanent structure operative to retain the relative position of at least one of the fire resistant layer and the thermal energy shield layer between the protectable asset and the pending threat so that the pending threat is inoperative to displace the protective barrier blanket from between the protectable asset and the pending threat. In another more detailed embodiment, the protectable asset includes at least one of a building, a portable structure, an automobile, and a mobile recreational vehicle.

It is a third aspect of the present invention to provide a protective system for use in separating a residential building from a destructive threat, the system comprising a protective barrier blanket comprising a plurality of protective segments including a fire resistant layer and a thermal energy protective layer, the plurality of protective segments being adapted to be interconnected and deployed in relation to a residential building to reduce exposure to a destructive threat of at least one of fire and thermal energy.

In a more detailed embodiment of the third aspect, the protective system further comprises a plurality of retainers adapted to maintain the relative orientation of the protective barrier blanket between the destructive threat and the residential building, the retainers being secured to a structure mounted to the ground. In yet another more detailed embodiment, the protective system further comprises an enclosure adapted to house at least a portion of the protective barrier blanket prior to deployment of the protective barrier blanket. In a further detailed embodiment, the protective system further comprises a motorized assembly mounted to the protective barrier blanket and operative to at least one of deploy the protective barrier blanket and withdraw the protective barrier blanket from deployment. In still a further detailed embodiment, the motorized assembly is automated to deploy the barrier blanket subsequent to identifying the destructive threat. In a more detailed embodiment, the fire resistant layer includes at least one of a nonconductive carbonized acrylic fiber layer and a fiberglass layer, and the thermal energy protective layer includes an aluminum containing coating.

### BRIEF DESCRIPTION OF THE DRAWINGS

FIG. 1 is frontal view of an exemplary residential housing structure;

FIG. 2 is side view of the exemplary residential housing structure of FIG. 1;

FIG. 3 is a frontal view of an exemplary residential housing structure of FIG. 1, protected by a first exemplary embodiment of the present invention; and

FIG. 4 is a side view of the exemplary residential housing structure of FIG. 2, protected by the first exemplary embodiment of the present invention.

### DETAILED DESCRIPTION

The exemplary embodiments of the present invention are described and illustrated below to encompass apparatuses and associated methods to protect assets from degradation and/or destruction that might otherwise result from unprotected exposure to a fire or a high temperature thermal energy source. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below include optional steps and features that one of ordinary skill should recognize as not being a requisite to fall within the scope and spirit of the present invention.

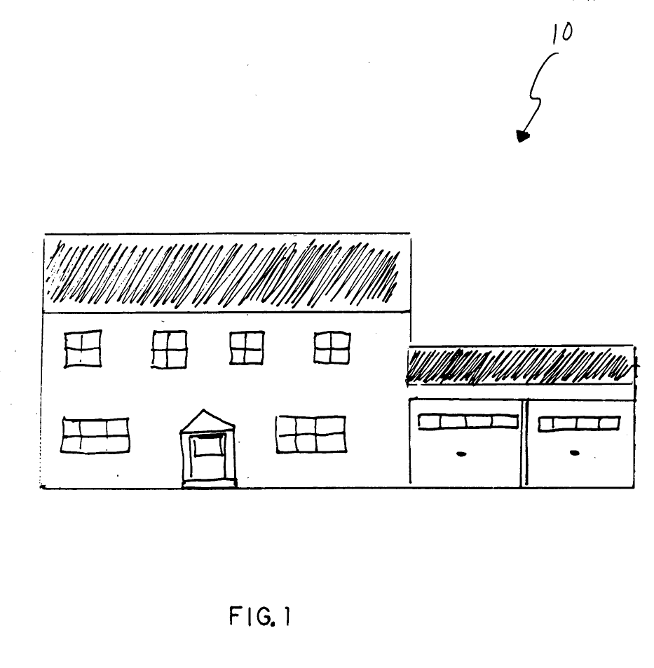

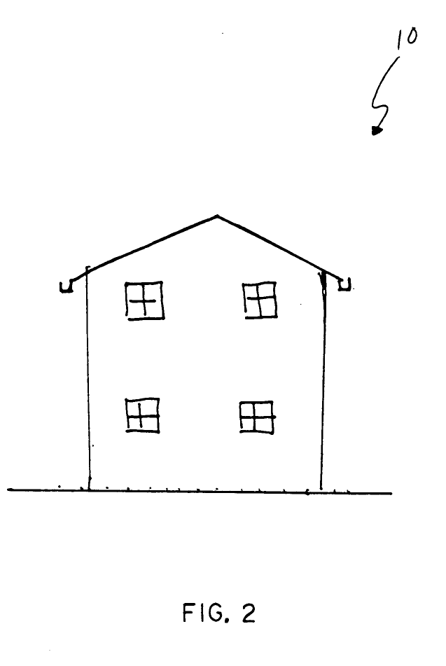

Referencing FIGS. 1 and 2, an exemplary structure 10 may represent a residential, commercial, industrial, institutional, or other building. For purposes of explanation only, the exemplary structure 10 discussed below will be referred to as a residential building, however, it is to be understood that the reference to a residential building may be replaced with reference to a commercial building, industrial building, institutional building, or any other building without requiring a separate explanation in order to practice the present invention.

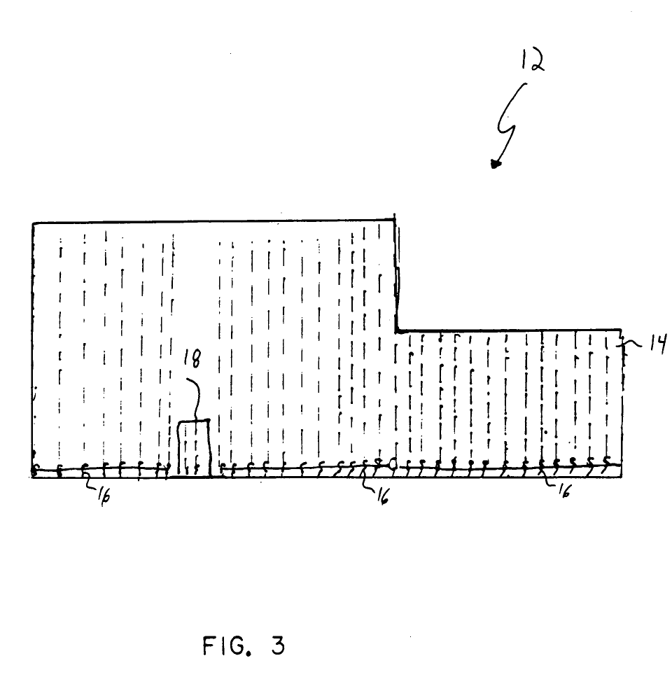

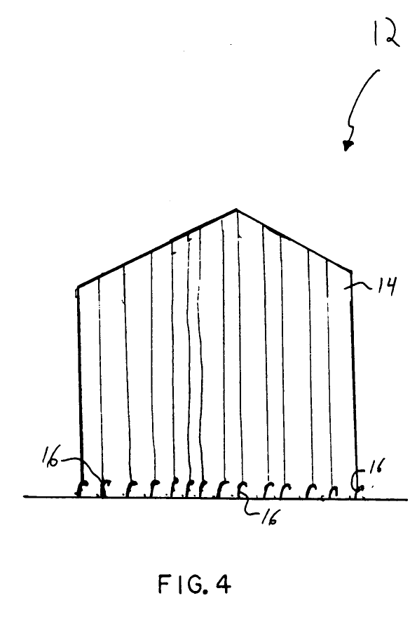

Referring to FIGS. 3 and 4, a first exemplary embodiment 12 comprises a thermal energy reflective and fire resistant blanket 14 adapted to protect the residential building 10 from a fire and/or a high temperature thermal energy source (collectively a “destructive threat”), such as, without limitation, a wildfire. The blanket 14 may be deployed over the entire residential building 10 or only over selected aspects of the residential building potentially exposed to the destructive threat.

An exemplary blanket 14 for use with the present invention may include a fire retardant layer and a heat resistive/reflective layer. The blanket 14 may include a nonconductive carbonized acrylic fiber layer (nonwoven, such as PXR available from N.L.F. Protective Services, Inc., of Dubuque, Iowa 52003) and/or a fiberglass layer (available from N.L.F. Protective Services, Inc., of Dubuque, Iowa 52003) including a coating applied thereto for at least one of fire and heat resistance. Exemplary coatings include aluminum foils and aluminum based coatings. Those of ordinary skill in the relevant art will recognize that alternate materials providing a fire retardant property and/or a heat resistive/reflective property may be utilized in place of or in combination with the exemplary materials discussed above.

Exemplary blankets 14 in accordance with the present invention may include reconfigurable segments amendable to conforming to the exterior features of the residential building 10 for a more tailored fit. Such segments may be cut and sewn, heat welded, or otherwise reconfigured and fastened together to accommodate the exterior features of the residential building 10. In addition, the segments of the blanket 14 may be permanently mounted to one another, or may be temporarily mounted to one another during the period of use, only thereafter to be disassembled for storage, egress, or other reasons.

Storage of the blanket 14 prior to deployment may be accomplished using one or more enclosures (not shown) positioned on the roof of the residential building 10 or near the building. An exemplary method of storing the blanket 14 may includes rolling up the entire blanket within a single enclosure or breaking down the blanket into two or more portions for storage within a plurality of enclosures. It is preferred that the blanket be stored in a manner to facilitate an organized and predictable withdrawal of the blanket 14 from the enclosure during deployment of the blanket.

For purposes of explanation, an exemplary deployment of the blanket includes draping the blanket 14 from the rooftop of the building 10. In this manner, the blanket 14 is unrolled or extended from the roof of the building 10 and directed downward toward the base of the building. It should be noted, however, that the blanket 14 is not required to fully reach the base of the building to impart protection. Deployment may optionally include bringing the blanket 14 in contact with the ground or another structure surrounding the residential building 10 to effectively seal off the building from an approaching fire and unwanted thermal energy source. As used herein, “sealing off” does not necessitate creating or maintaining and fluid-tight seal.

After the blanket 14 is initially deployed, it is mounted to one or more supports to secure the protective orientation of the blanket with respect to the building 10. This securing process may include repositioning the blanket 14 to eliminate appreciable gaps and openings that would otherwise enable direct contact between the building 10 and destructive threat. As used herein, protective orientation generally refers to, without limitation, an orientation of the blanket 14 operative to provide protection to the residential building 10 from the destructive threat. Cables, straps, chains, quick disconnect snaps, or come-alongs to ground anchors, or other fasteners 16 may be utilized to secure the blanket 14 in its protective position. The fasteners 16 may be heat and/or fire resistant and may comprise metals and other suitable materials sufficient to secure the blanket 14 in its protective position. Likewise, the blanket 14 may include eyelets or sockets for receiving fasteners 16, such as quick connect straps, already strategically positioned in proximity to the residential building 10. Still further, the blanket 14 may include fasteners 16, such as hooks integrally formed therein, some of which may be adapted to mount to a fixed or repositionable anchor. It may also be advantageous to provide fasteners 16 at predetermined spaced increments to increase the stability of the blanket 14. Such increased stability may be especially advantageous if and when the residential building 10 is subjected to severe gusts of the wind resulting from convection currents generated by the destructive threat.

The blanket 14 may be deployed manually, automatically, or using a combination of both in response to identifying a destructive threat to the residential building 10. Automatic deployment of the blanket 14 may include one or more motors engaging the enclosure and/or the blanket to reposition the blanket 14 to a protective orientation. In addition to, or in lieu of, motors, the blanket 14 may be repositioned using spring loaded mechanisms and/or carbon dioxide canisters. Those of ordinary skill will readily understand the scope of potential techniques and devices for use in such techniques for deploying the blanket 14.

It is also within the scope and spirit of the present invention to provide entrances and/or exits 18 within the blanket 14 that may correspond to those in the residential building 10, such as, without limitation, front doors, back doors, garage doors, etc., to enable egress into and from the residential building 10 while the blanket 14 is deployed and secured until such time as the residents of the residential building 10 must be evacuated or the destructive threat is alleviated.

It is likewise within the scope and spirit of the present invention to utilize a blanket to protect assets such as, without limitation, vehicles, recreational vehicles, mobile homes, utility trailers, boats, planes, etc. In each the aforementioned exemplary applications, a protective blanket may be stored remotely such as in a garage, or on-board the respective asset, and be adapted to be deployed manually or automatically to protect the asset from a destructive threat. The blanket may be secured to the ground, to another fire or thermal energy barrier, or otherwise secured to seal off the asset from the destructive threat.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. A method of protecting an asset from destruction resulting from exposure to at least one of fire and thermal energy comprising:
identifying a pending threat capable of at least substantially destroying an asset by exposure to at least one of fire and thermal energy;
deploying a barrier, that includes a fire resistant layer and a thermal energy reflective layer, to separate the asset from the pending threat; and
securing the barrier to at least one of the ground, the asset itself, and a support structure;
wherein the act of securing the barrier is operative to retain at least one of the fire resistant layer and the thermal energy shield layer between the asset and the pending threat.

2. The method of claim 1, wherein the barrier is a blanket.

3. The method of claim 2, wherein:
the barrier is secured to the ground; and
securing the barrier to the ground includes coupling the barrier to anchors secured in the ground.

4. The method of claim 2, further comprising mounting an enclosure to the asset, where the enclosure is adapted to house at least a portion of the barrier prior to deployment of the barrier.

5. The method of claim 1, further comprising mounting an enclosure in close proximity to the asset, where the enclosure is adapted to house at least a portion of the barrier prior to deployment of the barrier.

6. The method of claim 1, wherein the asset includes at least one of a residential structure, a commercial structure, an industrial structure, and an institutional structure.

7. The method of claim 6, wherein:
the asset includes a residential structure; and
the method further includes the act of mounting an enclosure, housing at least a portion of the barrier therein, to at least one of a roof, a wall, and a framing structure associated with the residential structure to facilitate rapid deployment of the barrier subsequent to identification of the pending threat.

8. The method of claim 1, wherein:
the fire resistant layer includes at least one of a nonconductive carbonized acrylic fiber layer and a fiberglass layer; and
the thermal energy reflective layer includes an aluminum containing coating.

9. A protective apparatus for use in isolating protectable assets from substantial destruction resulting from at least one of fire and thermal energy, the protective barrier comprising:
a protective barrier blanket that includes a fire resistant layer operatively coupled to a thermal energy shield layer, the fire resistant layer adapted to at least partially interpose the thermal energy shield layer and a protectable asset, wherein at least one of the fire resistant layer and the thermal energy shield layer is at least partially operative to reduce exposure of the protectable asset from a pending threat of at least one of fire and thermal energy; and
fasteners operatively coupled to at least one of the fire resistant layer and the thermal energy shield layer, the fasteners adapted to retain in relative position at least one of the fire resistant layer and the thermal energy shield layer between the protectable asset and the pending threat.

10. The protective apparatus of claim 9, further comprising an enclosure for housing at least a portion of the protective barrier blanket.

11. The protective apparatus of claim 10, wherein the enclosure is at least one of permanently mounted and temporarily mounted to the protectable asset.

12. The protective apparatus of claim 10, wherein the enclosure is at least one of permanently mounted and temporarily mounted in proximity to the protectable asset.

13. The protective apparatus of claim 10, wherein the enclosure automatically opens to provide access to the protective barrier blanket in response to detection of the pending threat.

14. The protective apparatus of claim 9, wherein the fasteners include anchors mounted to a permanent structure operative to retain the relative position of at least one of the fire resistant layer and the thermal energy shield layer between the protectable asset and the pending threat so that the pending threat is inoperative to displace the protective barrier blanket from between the protectable asset and the pending threat.

15. The protective apparatus of claim 9, wherein the protectable asset includes at least one of a building, a portable structure, an automobile, and a mobile recreational vehicle.

16. A protective system for use in separating a residential building from a destructive threat, the system comprising:
a protective barrier blanket comprising a plurality of protective segments including a fire resistant layer and a thermal energy protective layer, the plurality of protective segments being adapted to be interconnected and deployed in relation to a residential building to reduce exposure to a destructive threat of at least one of fire and thermal energy.

17. The protective system of claim 16, further comprising a plurality of retainers adapted to maintain the relative orientation of the protective barrier blanket between the destructive threat and the residential building, the retainers being secured to a structure mounted to the ground.

18. The protective system of claim 16, further comprising an enclosure adapted to house at least a portion of the protective barrier blanket prior to deployment of the protective barrier blanket.

19. The protective system of claim 16, further comprising a motorized assembly mounted to the protective barrier blanket and operative to at least one of deploy the protective barrier blanket and withdraw the protective barrier blanket from deployment.

20. The protective system of claim 19, wherein the motorized assembly is automated to deploy the barrier blanket subsequent to identifying the destructive threat.

21. The protective system of claim 16, wherein:
the fire resistant layer includes at least one of a nonconductive carbonized acrylic fiber layer and a fiberglass layer; and
the thermal energy protective layer includes an aluminum containing coating.
